(19) United States
(12) Patent Application Publication
(10) Pub. No.: US 2014/0144238 A1
(43) Pub. Date: May 29, 2014

(54) SENSOR ARRAY FOR PIPELINE CORROSION MONITORING

(71) Applicant: GENERAL ELECTRIC COMPANY, Schenectady, NY (US)

(72) Inventor: Wei Luo, Chandler, AZ (US)

(73) Assignee: GENERAL ELECTRIC COMPANY, Schenectady, NY (US)

(21) Appl. No.: 13/687,165

(22) Filed: Nov. 28, 2012

(51) Int. Cl. G01N 29/22

(52) U.S. Cl. CPC G01N 29/223
USPC 73/590; 73/622

(57) ABSTRACT

An ultrasonic sensor assembly for a test pipe includes a sensor array. The sensor array includes a plurality of sensor elements for detecting a characteristic of the test pipe and included a flexible backing material on which the plurality of sensor elements are supported. The sensor array is adjustable in length to form an adjusted length. An excess portion is removed from the sensor array to form the adjusted length. This adjusted length of the sensor array substantially matches a perimeter distance around an outer surface of the test pipe. An associated method of positioning the ultrasonic sensor assembly on the test pipe is also provided.

### BACKGROUND OF THE INVENTION

1. Field of the Invention

The present invention relates generally to ultrasonic sensor assemblies, and more particularly, to an ultrasonic sensor assembly that is adjustable in length.

2. Discussion of the Prior Art

Ultrasonic sensor assemblies are known and used in many different applications. Ultrasonic sensor assemblies are used, for example, to inspect a test object and detect/identify characteristics of the test object, such as corrosion, defects, length, thickness, etc. In pipeline corrosion monitoring applications, the test object can include a test pipe. In such an example, one or more ultrasonic sensor assemblies are wrapped around an outer surface of the test pipe during inspection. However, ultrasonic sensor assemblies of varying lengths are needed to accommodate test pipes of different diameters. Further, a number of different tools are required to properly attach these ultrasonic sensor assemblies to the test pipes. Accordingly, it would be beneficial to provide an ultrasonic sensor assembly that is adjustable in length to match test pipes of varying sizes. Further, it would be beneficial to provide this adjustment in length and attachment to the test pipes without the need for tools, utensils, etc.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides an ultrasonic sensor assembly for a test pipe. The ultrasonic sensor assembly includes a sensor array. The sensor array includes a plurality of sensor elements for detecting a characteristic of the test pipe and includes a flexible backing material on which the plurality of sensor elements are supported. The sensor array is adjustable in length to substantially match a perimeter distance around an outer surface of the test pipe.

In accordance with another aspect, the present invention provides an ultrasonic sensor assembly for a test pipe. The ultrasonic sensor assembly includes a sensor array including a plurality of sensor elements supported on a flexible backing material. The sensor array is adjustable in length to form an adjusted length. An excess portion is removable from the sensor array to form the adjusted length of the sensor array. The adjusted length substantially matches a perimeter distance around an outer surface of the test pipe.

In accordance with another aspect, the present invention provides a method of positioning an ultrasonic sensor assembly. The method includes the step of providing a test pipe having a perimeter distance around an outer surface of the test pipe. The method further includes the step of providing a sensor array including a plurality of sensor elements, wherein the sensor array has an initial length. The method includes the step of removing an excess portion of the length of the sensor array such that the sensor array has an adjusted length that substantially matches the perimeter distance of the test pipe. The method also includes the step of applying the sensor array to the test pipe such that the sensor array extends along a surface of the test pipe.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a perspective view of an example ultrasound sensor assembly for use with a test pipe in accordance with an aspect of the present invention;

FIG. 2 is a perspective view of an example sensor array of the ultrasound sensor assembly;

FIG. 3 is another perspective view of the example sensor array including a plurality of sensor elements and a perforation in the sensor array;

FIG. 4 is a perspective view of the example sensor array in which an excess portion of the sensor array has been removed; and

FIG. 5 is an end view of the example sensor array after the excess portion has been removed in which the sensor array is being attached to the test pipe.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

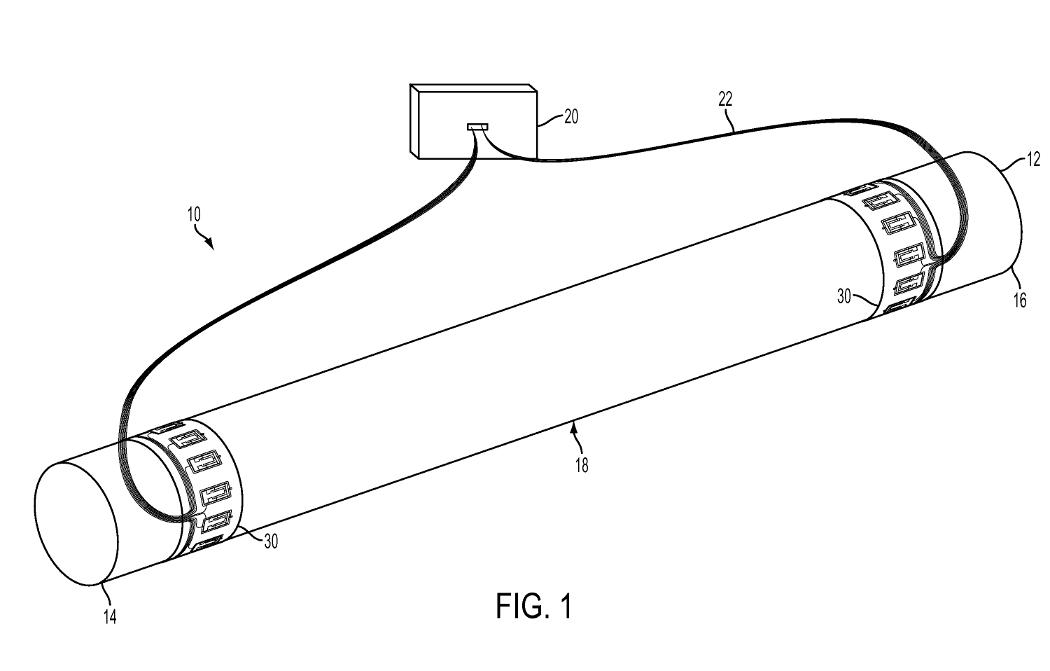

FIG. 1 illustrates a perspective view of an example ultrasonic sensor assembly 10 according to one aspect of the invention. In short summary, the ultrasonic sensor assembly 10 includes a sensor array 30 (including one or more transducer elements) attached to a test pipe 12. The sensor array 30 transmits (e.g., sends and/or receives) ultrasonic waves through the test pipe to detect characteristics of the test pipe 12. These characteristics include corrosion, wall thickness, defects, etc. The sensor array 30 is operatively attached to a test apparatus 20 by means of wires 22. To accommodate for varying sizes of the test pipe 12 (e.g., larger or smaller diameters), a length of the sensor array 30 can be adjusted so as to more closely match (e.g., substantially match) a perimeter distance around the test pipe.

The test pipe 12 is shown to have a generally cylindrical shape extending between a first end 14 and an opposing second end 16. The test pipe 12 can include a non-solid body (e.g., hollow body) or may be solid. It is to be appreciated that the test pipe 12 is somewhat generically/schematically depicted in FIG. 1 for ease of illustration. Indeed, the test pipe 12 is not limited to extending along a linear axis, and may include bends, undulations, curves, or the like. Further, while the test pipe 12 is shown to be cylindrical in shape, in other examples, the test pipe 12 could include other non-cylindrical shapes and sizes. For example, the test pipe 12 could have a non-circular cross-sectional shape, such as by having a square or rectangular cross-section. In other examples, the test pipe 12 further includes a tubular shape, conical shape, or the like. As such, the test pipe 12 shown in FIG. 1 comprises only one possible example of a test pipe.

The test pipe 12 could be longer or shorter in length than as shown. Further, the test pipe 12 may include a larger or smaller cross-sectional size (e.g., diameter in the shown example). The test pipe 12 includes an outer surface 18. The outer surface 18 defines a perimeter distance around the test pipe 12. For example, the perimeter distance of the cylindrically shaped test pipe in FIG. 1 is equivalent to the circumference of the test pipe 12. However, in examples when the test pipe 12 includes a non-cylindrical shape (e.g., by having a square or rectangular cross section), the perimeter distance of the test pipe 12 is equivalent to a perimeter of the test pipe 12 at a given cross-section. As such, the perimeter distance includes the length around the outer surface 18 of the test pipe 12 at a given cross-section.

The ultrasonic sensor assembly 10 further includes the test apparatus 20. The test apparatus 20 is somewhat generically/schematically depicted, as the test apparatus 20 includes any number of different configurations. In one example, the test apparatus 20 is operatively attached to the sensor array 30 by means of wires 22. As will be described in more detail below, the test apparatus 20 is configured to send and receive information from the sensor array 30 through the wires 22. This information can be related to characteristics of the test pipe 12. For example, in pipeline corrosion monitoring applications, the test pipe 12 may be susceptible to defects, such as corrosion, cracks, or the like. As such, this information can include, but is not limited to, dimensions of the test pipe 12 (e.g., thickness, length, etc.), the presence or absence of corrosion, cracks, or the like. The test apparatus 20 can include computers, ultrasound instruments (e.g., controllers/control devices, etc.), or the like. In further examples, the test apparatus 20 includes a user interface, display, and/or other devices for allowing a user to control the ultrasonic sensor assembly 10.

The ultrasonic sensor assembly 10 further includes the sensor array 30. In operation, the sensor array 30 is flexible and can be wrapped around the test pipe 12. The ultrasonic sensor assembly 10 can include a single sensor array, or a plurality of sensor arrays. In the shown example of FIG. 1, the ultrasonic sensor assembly 10 includes two sensor arrays. One of the sensor arrays 30 is positioned towards the first end 14 of the test pipe 12 while another of the sensor arrays 30 is positioned towards the second end 16 of the test pipe 12. Of course, in further examples, the sensor arrays 30 could be positioned at any number of locations along the test pipe 12, such as closer towards a center, closer towards the first end 14 or second end 16, etc. Indeed, the sensor arrays 30 could be positioned closer together or farther apart, and can inspect/detect characteristics of the test pipe 12 in the area between the sensor arrays 30.

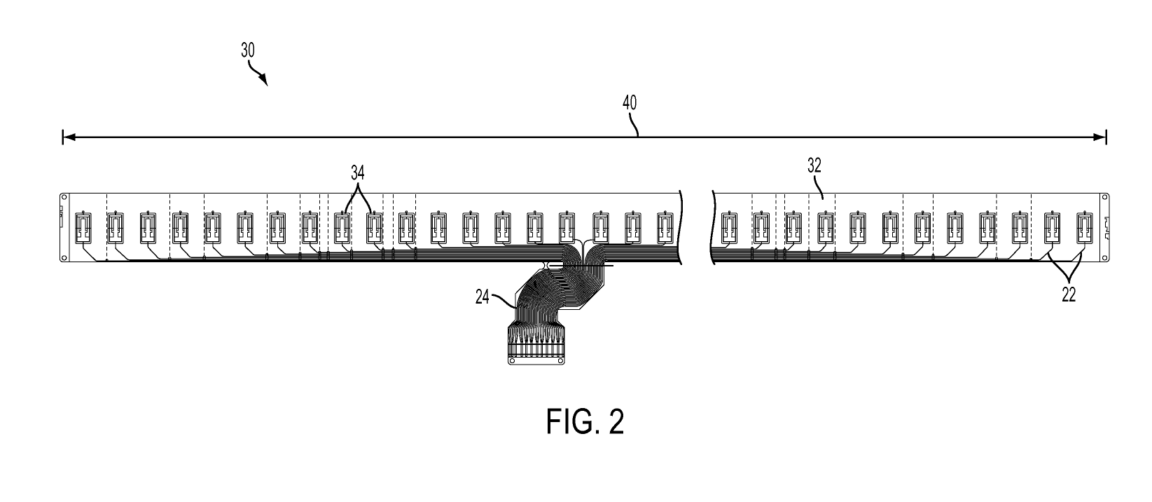

Turning now to FIG. 2, the sensor array 30 will be described in more detail. The sensor array 30 is shown to be detached from the test pipe 12 in FIG. 2 for illustrative purposes and to more clearly illustrate the elements of the sensor array 30. However, in operation, the sensor array 30 will extend around the test pipe 12 as described with respect to FIG. 1.

The sensor array 30 includes a backing material 32. The backing material 32 is a flexible, resilient material that extends along a length of the sensor array 30. The backing material 32 may include a number of different materials that allow for bending and for the sensor array 30 to be wrapped around the test pipe 12 at operating temperatures of the test pipe 12. The backing material 32 can include, for example, polyimide materials, Kapton, engineering plastics, etc. In further examples, a strengthening member, such as synthetic fibers, could also be added to the backing material 32 to provide further resiliency and reduce the likelihood of rips, tears, and general wear and tear of the sensor array 30.

The sensor array 30 further includes one or more sensor elements 34. The sensor elements 34 can include, for example, transducer elements that are linearly arranged to extend along the length of the sensor array 30 in a generally straight line. Of course, in other examples, the sensor elements 34 could be staggered along the sensor array 30, such that the sensor elements 34 are non-linearly arranged. The sensor elements 34 are supported by the backing material 32. In particular, the sensor elements 34 can be attached to, fixed to, etc. the backing material 32. In one example, the sensor elements 34 are equidistant from each other, such that the sensor elements 34 are substantially equally spaced apart along the sensor array 30. In particular, the sensor elements 34 are equally spaced from adjacent sensor elements along the length of the sensor array 30. The sensor elements 34 can be spaced closer together or farther apart than as shown in FIG. 2. In one example, the sensor elements 34 can be spaced approximately 13 mm (0.5″) apart, though other distances are envisioned. Further, while 32 sensor elements are shown in FIG. 2, it is to be understood that greater than or less than this amount can be provided. The sensor elements 34 can be formed of a number of different materials, including, for example, piezoelectric materials or the like.

The sensor elements 34 can include both transmitter elements and receiver elements. For example, when two sensor arrays are provided (as in the example of FIG. 1), one of the sensor arrays 30 can include transmitter elements while the other of the sensor arrays 30 can include receiver elements. In such an example, one of the sensor arrays 30 comprises a transmitting sensor array while the other of the sensor arrays 30 comprises a receiving sensor array. As such, the transmitting sensor array can be arranged on one side of the test pipe 12 (e.g., at the first end 14 while the receiving sensor array could be arranged in a spaced apart manner on the other side of the test pipe 12 (e.g., at the second end 16). Accordingly, the sensor elements 34 in the sensor array 30 of FIG. 2 represent either of the transmitter elements or the receiver elements or both (i.e., transducers). The transmitter elements can send signals through the test pipe 12. These signals include, for example, acoustic signals, acoustic waves, etc. These signals sent from the transmitter elements can be received by the receiver elements. The signals can be analyzed to determine characteristics of the test pipe 12 (e.g., defects, corrosion, cracks, etc.).

The sensor elements 34 are each operatively attached to the wires 22. As shown in FIG. 2, each of the sensor elements 34 includes one of the wires 22 extending from a rear surface of the sensor elements 34. The wires 22 are supported by the backing material 32. In the shown example, the wires 22 can be grouped together to form a wire bundle 24. The wire bundle 24 is shown to be positioned at a midpoint of the sensor array 30, but in further examples, could be positioned closer to one of the ends of the sensor array 30. The wire bundle 24 leads from the sensor array 30 to the test apparatus 20, with the wires 22 being operatively attached to the test apparatus 20. Since the wires 22 are operatively attached to each of the test apparatus 20 and sensor elements 34, the wires 22 will transmit information between the sensor elements 34 and the test apparatus 20. As such, the wires 22 allow for information to be exchanged (e.g., data, control instructions, etc.) between the sensor elements 34 and the test apparatus 20.

The sensor array 30 has a predetermined length 40. This length 40 can be longer or shorter than as shown. In some examples, this length 40 is longer than the perimeter distance (e.g., circumference) around the test pipe 12. Accordingly, without adjusting the length 40 of the sensor array 30, the sensor array 30 may be too long to fit around the test pipe 12. This can cause excess bundling or an excess portion of the sensor array 30 not being attached to the test pipe 12.

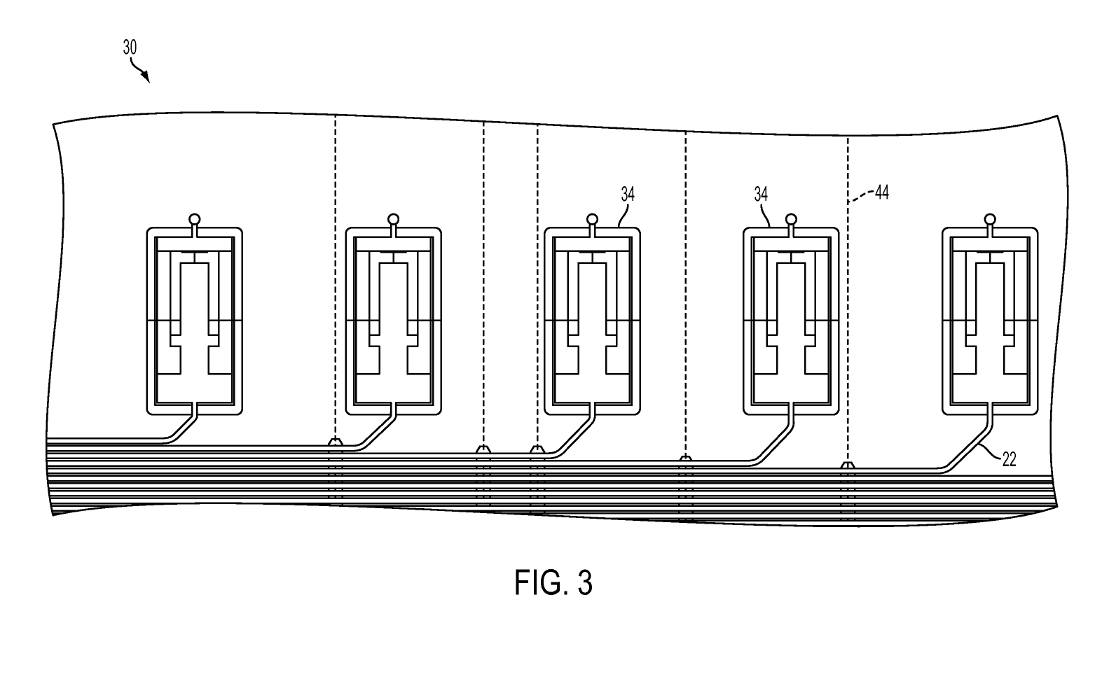

Turning now to FIG. 3, a portion of the sensor array 30 is shown. It is to be appreciated that while only a portion of the sensor array 30 is shown, the remaining, unshown portion of the sensor array 30 can be similar or identical in shape and structure as the example shown in FIG. 3. The sensor array 30 can be adjusted in length. In particular, the length 40 of the sensor array 30 (shown in FIG. 2) can be shortened to accommodate for different perimeter distances (e.g., circumferences) around the test pipe 12. In one example, to adjust the length 40 of the sensor array 30, the sensor array 30 includes a perforation 44. The perforation 44 includes one or more holes extending through the backing material 32 (and, in some examples, the wires 22). The perforation 44 can extend in a direction that is substantially transverse to the direction along which the sensor array 30 extends (e.g., length direction). The perforation 44 allows for relatively easier separation of excess portions of the sensor array 30, such that the sensor array 30 can be adjusted in length to substantially match the perimeter distance (e.g., circumference) around the test pipe 12. The sensor array 30 includes a plurality of perforations 44 spaced apart along the length 40 of the sensor array 30. As such, the desired length of the sensor array 30 can be adjusted accordingly by removing a portion of the sensor array 30 at the desired perforation 44.

Some of the wires 22 of the sensor array 30 may or may not remain attached to an excess length of the sensor array 30. In one possible example, the wires 22 of the excess length may be inoperative such that the excess length is not in use after separation. In another possible example, the wires 22 of the excess length could be separated along with the excess length of the sensor array 30. In such an example, these wires 22 could be detached from the wire bundle 24, such that the excess length of the sensor array 30, including the associated wires 22, is inoperative after separation.

It is to be appreciated that the perforation 44 comprises only one of a number of ways that the sensor array 30 can be adjusted in length. Indeed, in further examples, the sensor array 30 may or may not include the perforation 44 as shown. Instead, the sensor array 30 could be cut, such as with a knife, scissors, or similar cutting utensil. In such an example, the perforation 44 may not be needed, as a user could determine the ideal spot to cut the sensor array 30 to adjust the length 40. In other examples, the perforation 44 includes pre-printed lines. These perforations/lines can be pre-calculated based on standard industry pipe sizes (e.g., circumference, etc.). A combination of these lines will allow for different pipe sizes. In addition, a label of pipe sizes can be pre-printed next to the lines/perforations for cutting.

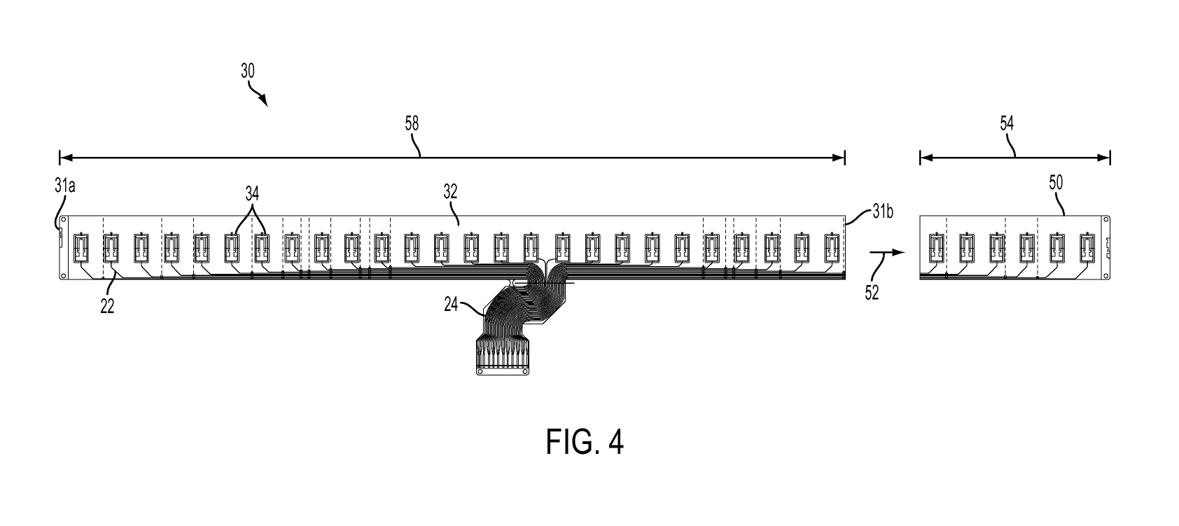

Turning now to FIG. 4, the method of adjusting the length of the sensor array 30 will now be described. Initially, a user will know the perimeter distance (e.g., circumference) of the test pipe 12. This perimeter distance may be ascertained by measuring or may already be known. In some examples, the length 40 of the sensor array 30 is longer than this perimeter distance, such that the sensor array 30 can be adjusted to substantially match the perimeter distance. By substantially matching the perimeter distance of the test pipe 12, the sensor array 30 is ensured a close fit with the outer surface 18 of the test pipe 12 with reduced overlaps, creases, folding, etc. of the sensor array 30. By reducing overlaps, creases, folding, etc. of the sensor array 30, the effectiveness of the sensor array 30 is improved. In one scenario, the substantial matching includes the aspect that the maximum number of sensor elements 34 are present within the adjusted length without overlap of the sensor array when the sensor array 30 is wrapped around an outer surface of the test pipe. It is to be appreciated that some small gap may be present, but that the gap is not large enough to accommodate one more sensor element 30. In another scenario, substantially matching includes an exact match (i.e., no gap). In other examples, at least some overlap could be present, such as by one end of the sensor array 30 overlapping another end of the sensor array 30.

Once the perimeter distance of the test pipe 12 is known, an excess portion 50 of the sensor array 30 can be removed so as to adjust the overall length of the sensor array 30. This excess portion 50 includes an excess length 54 that represents the difference between the original length 40 of the sensor array 30 and the perimeter distance of the test pipe 12. The excess portion 50 can be removed in any number of ways. For example, as described above, the excess portion 50 can be torn along one of the perforations 44 (as shown in FIG. 4) to remove the excess portion 50 from the sensor array 30. In other examples, the excess portion 50 could be cut and removed from the sensor array 30 with cutting utensils. A removal 52 of the excess portion 50 is shown somewhat generically in FIG. 4 with an arrowhead.

Once the excess portion 50 has been removed, the sensor array 30 has an adjusted length 58. This adjusted length 58 represents the length of the sensor array 30 between a first array end 31a and an opposing second array end 31b. The adjusted length 58 of the sensor array 30 substantially matches the perimeter distance of the test pipe 12, such that the sensor array 30 can be wrapped around the test pipe 12. Once the sensor array 30 is applied to the test pipe 12, data will not be derived from the excess portion 50. In particular, the test apparatus 20 will not receive information from the excess portion 50, and will only receive information from (and send information to) the sensor array 30 having the adjusted length 58. It is to be appreciated that the excess portion 50 is not limited to being removed from one end of the sensor array 30. Rather, in other examples, the excess portion 50 may be removed from both ends of the sensor array 30 (e.g., first array end 31a and second array end 31b). In this example, the test apparatus 20 may not recognize the excess portion(s) 50.

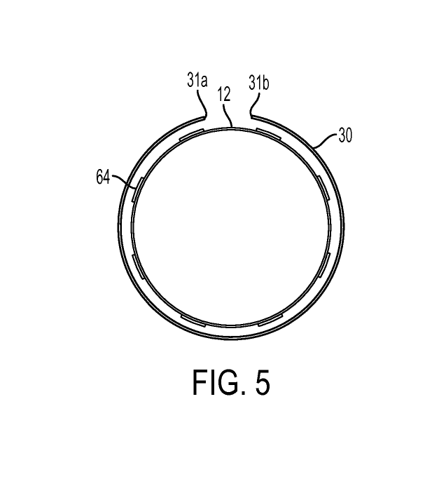

Turning now to FIG. 5, the sensor array 30 is shown in the process of being attached to the test pipe 12. In particular, the sensor array 30 can be wrapped around the outer surface 18 of the test pipe 12. While the sensor array 30 is shown being attached to the outer surface 18, the sensor array 30 is not so limited. Rather, in other examples, the sensor array 30 can extend along a surface of the test pipe 12 (i.e., outer surface 18, inner surface, etc.). The adjusted length 58 of the sensor array 30 substantially matches the perimeter distance of the test pipe 12. As such, the first array end 31a and second array end 31b can be brought closer together as the sensor array 30 is wrapped around the test pipe 12. It is to be appreciated that the first array end 31a and second array end 31b are shown to be spaced apart in FIG. 5, since the sensor array 30 is not fully attached to the test pipe 12. Rather, the sensor array 30 is in the process of being attached. However, once the sensor array 30 is fully attached (as in FIG. 1), the first array end 31a and second array end 31b can be in contact with each other, or nearly in contact with each other.

In one example, the sensor array 30 is fixedly and non-removably attached to the test pipe 12. To attach the sensor array 30, a fastener 64 is provided. While the fastener 64 is shown to be attached only to the test pipe 12 in FIG. 5, in further examples, the fastener 64 can be applied to either or both of the sensor array 30 or the test pipe 12. The fastener 64 includes any number of materials, such as adhesives including solder, epoxy, glue, or the like. In other examples, the fastener 64 includes mechanical fasteners, such as nuts, bolts, screws, etc. While the fastener 64 in FIG. 5 is shown to extend non-consecutively around the test pipe 12, in other examples, the fastener 64 can extend completely around the test pipe 12 or around an inner surface of the sensor array 30. In further examples, the fastener 64 allows for the sensor array 30 to be removably attached to the test pipe 12. For example, the fastener 64 may include a hook and loop type fastener or other similar temporary fasteners. In such an example, the hook and loop type fastener may be provided only on the sensor array 30, such as at the first array end 31 a and second array end 31b. As such, when the sensor array 30 is wrapped around the test pipe 12, the first array end 31a and second array end 31b can fasten to each other. It is to be understood, however, that other means for fastening the sensor array 30 to the test pipe 12 are also envisioned. For instance, in the aforementioned removable attachment, the fastener 64 is not limited to be between the test pipe 12 and the sensor array 30. Rather, the fastener 64 can be applied on the outside surface of the sensor array 30, such as, for example, a clamp or the like.

The sensor array 30 of the present disclosure is adjustable in length. As such, the sensor array 30 can be adjusted to match different perimeter distances around test pipes 12 of varying sizes. By providing the sensor array 30 as being adjustable in length, tools may no longer be needed for attaching or aligning the sensor array 30 to the test pipe 12. Further, it may no longer be necessary to manufacture the sensor arrays 30 to exactly match the perimeter distance of a specific test pipe. Instead, the sensor array 30 could be provided with the length being adjusted upon determining the perimeter distance of the test pipe 12.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An ultrasonic sensor assembly for a test pipe, the ultrasonic sensor assembly including:
a sensor array including a plurality of sensor elements for detecting a characteristic of the test pipe and including a flexible backing material on which the plurality of sensor elements are supported, the sensor array being adjustable in length to substantially match a perimeter distance around an outer surface of the test pipe.

2. The ultrasonic sensor assembly of claim 1, wherein the sensor elements are linearly arranged along the length of the sensor array.

3. The ultrasonic sensor assembly of claim 2, wherein the sensor elements are spaced equidistant from each other along the length of the sensor array.

4. The ultrasonic sensor assembly of claim 2, wherein each of the sensor elements includes at least one wire in operative attachment with the sensor elements.

5. The ultrasonic sensor assembly of claim 4, wherein the at least one wire is in further operative attachment with a test apparatus, the at least one wire exchanging information between the test apparatus and the sensor elements.

6. The ultrasonic sensor assembly of claim 1, wherein the sensor array is adjustable in length by removing an excess portion of the sensor array, wherein the excess portion of the sensor array includes an excess portion of the plurality of sensors and an excess portion of the backing material.

7. The ultrasonic sensor assembly of claim 6, wherein the sensor array is flexed to wrap around the outer surface of the test pipe such that the sensor array extends completely around the outer surface of the test pipe.

8. The ultrasonic sensor assembly of claim 7, wherein the sensor array is attached to the outer surface of the test pipe with a fastener.

9. The ultrasonic sensor assembly of claim 8, wherein the fastener includes glue.

10. The ultrasonic sensor assembly of claim 1, wherein the characteristics include corrosion of the test pipe.

11. The ultrasonic sensor assembly of claim 1, wherein the characteristics include thickness of the test pipe.

12. An ultrasonic sensor assembly for a test pipe, the ultrasonic sensor assembly including:
a sensor array including a plurality of sensor elements supported on a flexible backing material, the sensor array being adjustable in length to form an adjusted length by having an excess portion that is removable from the sensor array, wherein the adjusted length substantially matches a perimeter distance around an outer surface of the test pipe.

13. The ultrasonic sensor assembly of claim 12, wherein each of the sensor elements includes at least one wire in operative attachment with the sensor elements.

14. The ultrasonic sensor assembly of claim 13, wherein the at least one wire is in further operative attachment with a test apparatus, the at least one wire exchanging information between the test apparatus and the sensor elements.

15. The ultrasonic sensor assembly of claim 12, wherein the test pipe includes a cylindrical shape and the sensor array is flexed to substantially match the cylinder shape.

16. The ultrasonic sensor assembly of claim 15, wherein the perimeter distance around the outer surface of the test pipe is a circumference and the sensor array is adjusted via removal of the excess portion to substantially match the circumference.

17. The ultrasonic sensor assembly of claim 12, wherein the test pipe includes a non-cylindrical shape and the sensor array is flexed to substantially match the non-cylinder shape.

18. A method of positioning an ultrasonic sensor assembly, the method including the steps of:
providing a test pipe having a perimeter distance around an outer surface of the test pipe;
providing a sensor array including a plurality of sensor elements supported on a flexible backing material, the sensor array having an initial length;
removing an excess portion of the length of the sensor array such that the sensor array has an adjusted length that substantially matches the perimeter distance of the test pipe; and
applying the sensor array to the test pipe such that the sensor array extends along a surface of the test pipe.

19. The method of positioning the ultrasonic sensor assembly of claim 18, further including the step of transferring information between the sensor elements and a test apparatus.

20. The method of positioning the ultrasonic sensor assembly of claim 19, wherein information is not derived from the excess portion of the sensor array.
